(19) United States
(12) Patent Application Publication
(10) Pub. No.: US 2011/0239408 A1
(43) Pub. Date: Oct. 6, 2011

(54) HINGE

(75) Inventor: JUNG-BIN CHANG, Tu-Cheng (TW)

(73) Assignee: HON HAI PRECISION INDUSTRY CO., LTD., Tu-Cheng (TW)

(21) Appl. No.: 12/766,837

(22) Filed: Apr. 23, 2010

(30) Foreign Application Priority Data
Mar. 30, 2010 (TW) 99205581

(51) Int. Cl. E05D 5/10

(52) U.S. Cl. 16/386

(57) ABSTRACT

A hinge includes a fixing member, a shaft non-rotatably fixed to the fixing member, two shaft sleeves, and a rotating member. The shaft includes a shaft rod. Each shaft sleeve includes a sleeve portion rotatably fitting about the shaft rod, and a fixing board. A protrusion protrudes from each fixing board. The rotating member defines a receiving hole to fixedly accommodate the fixing boards, and a T-shaped fixing slot communicating with the receiving hole. The shaft rod is rotatably inserted into the receiving hole, together with the shaft sleeves, and the protrusions of the shaft sleeves overlap with each other, and are fixedly engaged in the fixing slot.

### BACKGROUND

1. Technical Field

The disclosure relates to a hinge.

2. Description of Related Art

A collapsible device, such as a notebook computer, or a clamshell mobile phone, generally includes a main body and a display, often using a hinge to interconnect the main body and the display.

The hinge includes a shaft sleeve, and a shaft rotatably received in the shaft sleeve. The shaft is in frictional engagement with an inner wall of the shaft sleeve during rotation of the shaft relative to the shaft sleeve. Therefore, the display can retain at any angle with respect to the main body from friction between the shaft and the shaft sleeve. However, after frequent usage, the shaft sleeve can be worn or become deformed. As a result, the display is no longer able to stay at certain positions or the shaft may become disengaged from the shaft sleeve. This becomes inconvenient for the user.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a hinge.

FIG. 2 is similar to FIG. 1, but viewed from another perspective.

FIG. 3 is a partially assembled, isometric view of the hinge of FIG. 2.

FIG. 4 is a fully assembled, isometric view of the hinge of FIG. 2.

FIG. 5 is a cross-section of the hinge of FIG. 4, taken along the line V-V.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

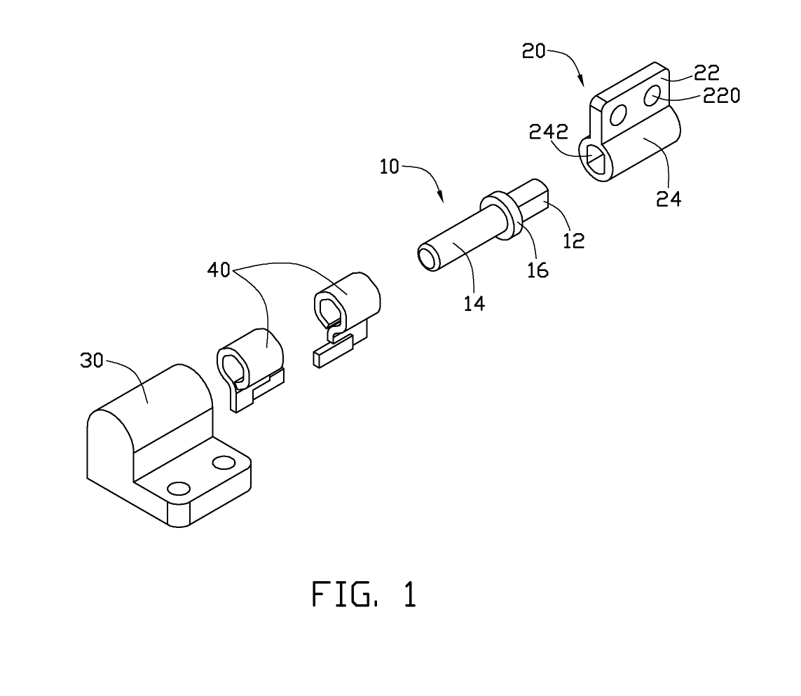

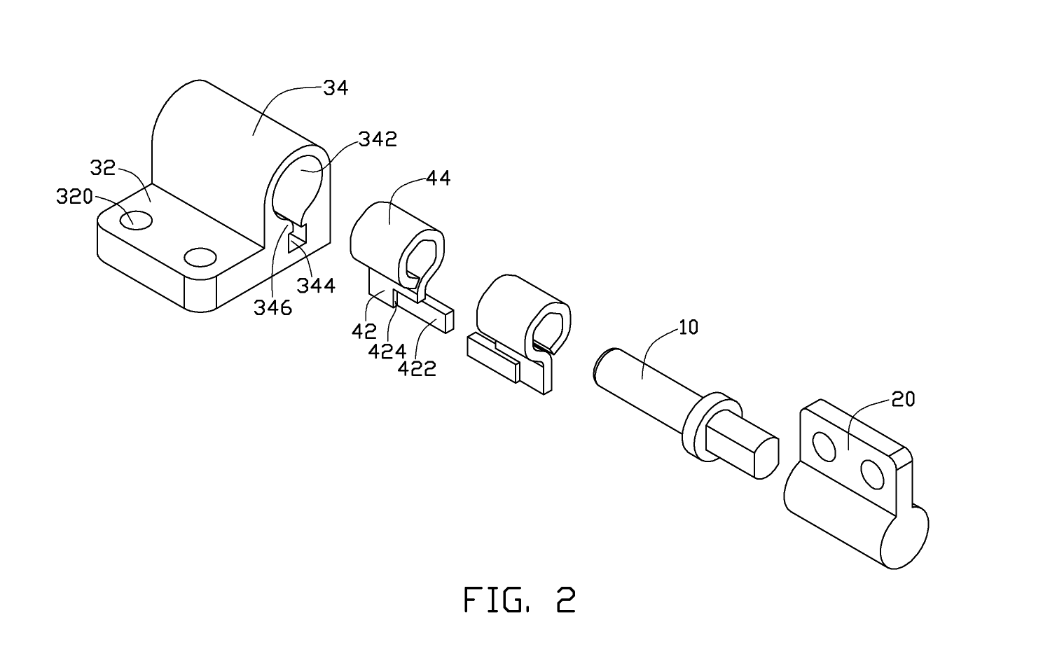

Referring to FIGS. 1 and 2, in an exemplary embodiment, a hinge includes a shaft 10, a fixing member 20, a rotating member 30, and two shaft sleeves 40.

The shaft 10 includes a fixing portion 12 having a substantially double D-shaped cross-section, a shaft rod 14 opposite to the fixing portion 12, and a washer-shaped resisting portion 16 between the fixing portion 12 and the shaft rod 14. The shaft rod 14 and the resisting portion 16 each have a substantially circular cross-section, and the resisting portion 16 has a greater diameter than the shaft rod 14.

The fixing member 20 includes a connecting portion 22 defining a plurality of fixing holes 220 therein, and a fixing portion 24 extending from a side of the connecting portion 22. The fixing portion 24 axially defines a substantially double-D shaped engaging hole 242, corresponding to the fixing portion 12 of the shaft 10, for fixing the shaft 10 in a non-rotatably manner to the fixing member 20.

The rotating member 30 includes a fixing arm 32 defining a plurality of fixing holes 320 therein, and a receiving portion 34 located at a side of the fixing arm 32. The receiving portion 34 axially defines a round receiving hole 342 and a T-shaped fixing slot 344. A smaller end of the fixing slot 344 communicates with a bottom of the receiving hole 342. Two opposite resisting ribs 346 protruding inwardly are defined in the fixing slot 344 from opposite sidewalls bounding the smaller end of the fixing slot 344.

Each shaft sleeve 40 includes a L-shaped fixing board 42, and a sleeve portion 44 having a generally C-shaped cross-section. A long side of the fixing board 42 extends and convolutes to form the sleeve portion 44. A protrusion 422 protrudes out from an inner end of the fixing board 42. The protrusion 422 extends along a direction parallel to an axis of the sleeve portion 44, with a distal end of the protrusion 422 extending out from the fixing board 42. Therefore, a step 424 forms between each end of the protrusion 422 and corresponding side surfaces of the fixing board 42.

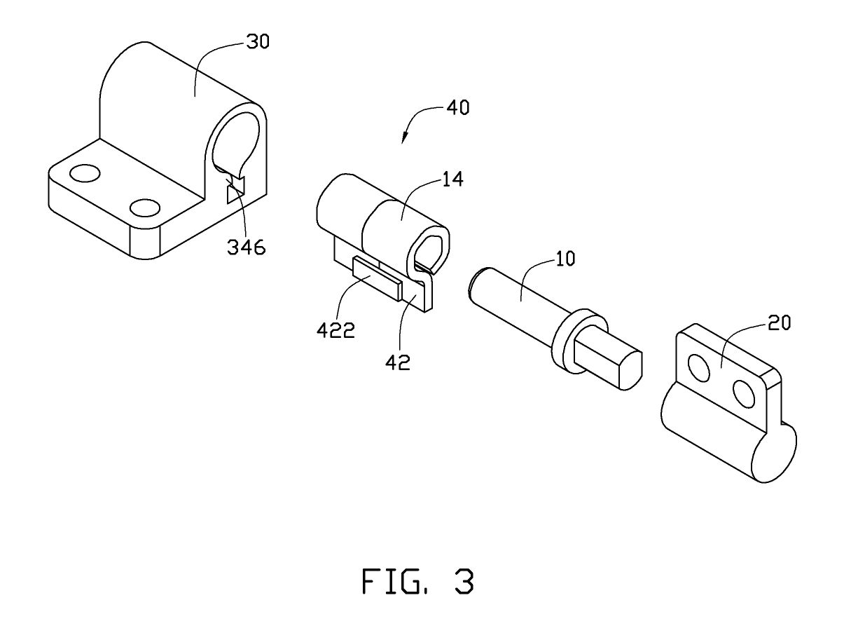

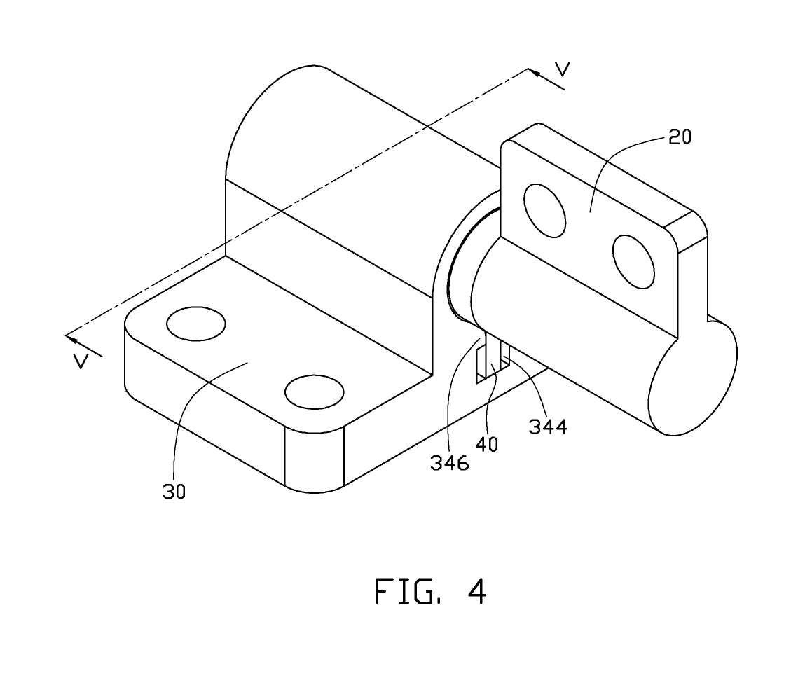

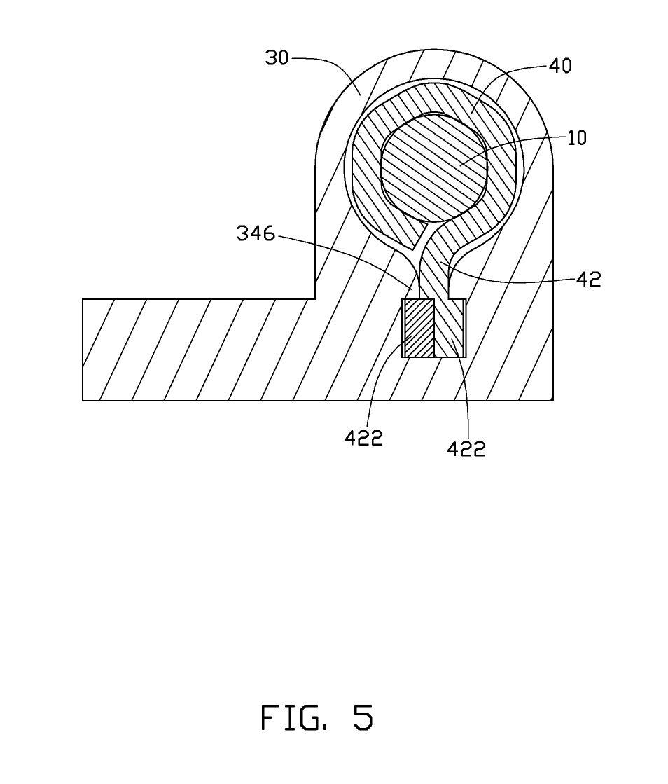

Referring to FIGS. 3 to 5, in assembly, the fixing portion 12 of the shaft 10 is fixedly received in the engaging hole 242 of the fixing member 20. Thereby, the shaft 10 is non-rotatably fixed to the fixing member 20, with the resisting portion 16 of the shaft 10 abutting against an end of the fixing portion 24 of the fixing member 20. The shaft rod 14 of the shaft 10 is rotatably extended through the sleeve portions 44 of the shaft sleeves 40 in that order. Thereby, each shaft sleeve 40 can move along the shaft rod 14 to abut against each other, with the protrusions 422 of the shaft sleeves 40 overlapping with each other. In this state, the thickness of the overlapping protrusions 422 is substantially equal to the width of a larger end of the fixing slot 344 of the rotating member 30. A distal end of the protrusion 422 of each fixing board 42 resists against the step 424 of the other fixing board 42. Thereafter, the shaft rod 14 is rotatably inserted into the receiving hole 342 of the rotating member 30, together with the shaft sleeves 40. The fixing boards 42 are accommodated in the smaller end of the fixing slot 344, and the overlapping protrusions 422 are accommodated in the greater end of the fixing slot 344, with the resisting ribs 346 of the rotating member 30 resisting against the fixing boards 42, correspondingly. As a result, the shaft sleeves 40 are fixedly mounted to the rotating member 30, which limits radial deformation of the shaft sleeves 40. The sleeve portions 44 of the shaft sleeves 40 firmly resist against the shaft rod 14, to prevent the shaft 10 from disengaging from the rotating member 30.

It is believed that the present embodiment and its advantages will be understood from the foregoing description, and it will be apparent that various changes may be made thereto without departing from the spirit and scope of the description or sacrificing all of its material advantages, the example hereinbefore described merely being exemplary embodiment.

What is claimed is:

1. A hinge comprising:
a fixing member;
a shaft non-rotatably fixed to the fixing member, the shaft comprising a shaft rod;
two shaft sleeves each comprising a sleeve portion rotatably fitting about the shaft rod, and a fixing board, a protrusion protruding from each fixing board; and
a rotating member defining a receiving hole to fixedly accommodate the fixing boards, and a T-shaped fixing slot communicating with the receiving hole;
wherein the shaft rod is rotatably inserted into the receiving hole, together with the shaft sleeves, the protrusions of the shaft sleeves overlap with each other, and are fixedly engaged in the fixing slot.

2. The hinge of claim 1, wherein a smaller end of the fixing slot communicates with the receiving hole, the thickness of the overlapping protrusions is substantially equal to the width of a larger end of the fixing slot.

3. The hinge of claim 1, wherein a side of each fixing board extends and convolutes to form the sleeve portion, the protrusion protrudes out from an end of the fixing board, and a step is formed between the protrusion and the fixing board.

4. The hinge of claim 3, wherein the shaft sleeves abut against each other, a distal end of the protrusion of each fixing board resists against the step of the other fixing board.

5. The hinge of claim 1, wherein the fixing board is generally L-shaped, and the sleeve portion having a generally C-shaped cross-section and is formed at a long side of the fixing board.

6. The hinge of claim 6, wherein the protrusion protrudes out from an inner end of the fixing board, and a step is formed between the inner end of the protrusion and the fixing board.

7. The hinge of claim 6, wherein the shaft sleeves abut against with each other, a distal end of the protrusion of each fixing board resists against an inner end of the other fixing board.

8. The hinge of claim 6, wherein a smaller end of the fixing slot communicates with the receiving hole, the thickness of the overlapping protrusions is substantially equal to the width of a larger end of the fixing slot.

9. The hinge of claim 8, wherein two opposite resisting ribs protruding inwardly are defined in the fixing slot from opposite sidewalls of the smaller end bounding the smaller end of the fixing slot, the resisting ribs resist against the fixing boards, respectively.

10. The hinge of claim 1, wherein the sleeve portions are movable along the shaft rod to abut against each other, for allowing the protrusions to overlap, a distal end of the protrusion of each fixing board resists against the other fixing board.

11. The hinge of claim 10, wherein a smaller end of the fixing slot communicates with the receiving hole, the thickness of the overlapping protrusions is substantially equal to the width of a larger end of the fixing slot.
